(19) United States
(12) Patent Application Publication
(10) Pub. No.: US 2011/0127478 A1
(43) Pub. Date: Jun. 2, 2011

(54) HANG-UP DEVICE FOR AN ALL-TERRAIN VEHICLE

(75) Inventor: Ludwig GIRITZER, Berchtesgaden-Engedey (DE)

(73) Assignee: Ludwig GIRITZER, Berchtesgaden-Engedey (DE)

(21) Appl. No.: 12/956,719

(22) Filed: Nov. 30, 2010

(30) Foreign Application Priority Data
Dec. 1, 2009 (DE) 10 2009 056 482.9

(51) Int. Cl. B66C 1/34; B66D 1/00; B66D 1/60

(52) U.S. Cl. 254/323; 294/82.11

(57) ABSTRACT

Apparatus for fastening an all-terrain vehicle (F) on steep terrain at stationary hang-up means (8), said vehicle having hauling means (9) attached thereto and a hook (2) attached to hauling means (9), with a movable coupling head (1) attached to hauling means (9) and mounting hook (2) for pivoting between a closed position in which tip (5) of hook (2) is moved towards movable coupling head (1), and a release position in which said tip (5) is pivoted away from movable coupling head (1). Also provided are a latching bolt (17) for latching hook (2) in place and guided for sliding movement on movable coupling head, and remote control means for an actuator for releasing latching bolt (17).

The invention relates to apparatus for securing an all-terrain vehicle particularly on steep ground using hauling means attached to stationary hang-up means using a hook, as defined in the pre-characterizing portion of patent claim 1.

A hang-up device of this kind has been known by DE 10 2007 027 746 A1. Its pivoting head is secured to a crane or the like hoist by means of a cable or the like hauling means . On the side turned away from the hooking tip of the pivot spindle, the hook has an extension engaged by the latching bolt. In order to make sure that the secured object comes free from the hook only after it has been parked safely, the object in its closed position engages the hook at a place directly below the pivot spindle.

In order to prevent the object from coming free of the hook if the remote control is actuated inadvertently, it has been known by WO 2009/065484 A1 to provide in the hook a slot through which the pivot spindle extends and to spring-bias the hook against the pivot spindle, thus enabling the remote control device to be deactivated by a contact if a secured object pulls the pivot spindle downwards in the slot.

According to this prior art, the object is secured by the hook and the movable coupling head is fastened to some hauling device. There also is the case of the object being secured by hauling means to the movable coupling head and the hook being fastened in the closed position to some hang-up device such as a ring.

This applies to track-driven all-terrain vehicles for the preparation of skiing pistes on a mountain slope. To keep the vehicle chains from scraping ditches into the piste's snow blanket on steep terrain, the vehicle is equipped with a cable winch by which the vehicle is supposed to pull itself uphill. The cable has at its top end a hook engaging a shackle or the like hang-up device fixedly installed on a post, a tree or the like at the top of the slope.

Following preparation of the slope, the driver releases the hook at the top end thereof. At that point the vehicle is not attached any longer; driving downhill, it will again dig a ditch-like depression into the piste.

Thus the object underlying the invention is the provision of a device allowing the all-terrain vehicle, which is secured by a cable or the like hauling means and a hook at hang-up means, to be released under remote control also after it has moved downhill.

In accordance with the invention, this object is attained by the device characterized in patent claim 1; advantageous further developments of the invention are set forth in the dependent claims.

In accordance with the invention, the all-terrain vehicle is secured by hauling means fastened to the movable coupling head while the hook engages the stationary hang-up means. In the closed position of the hook, the hang-up means engages the hook at a point between the pivot spindle on the movable coupling head and the place where the hauling means is attached to the movable coupling head .

In particular, the all-terrain vehicle secured to the movable coupling head may be a chain-driven all-terrain track vehicle for preparing a skiing piste on a mountain slope. The hauling means may be a cable, a chain or the like. An all-terrain vehicle of this kind may have a cable winch by means of which it can pull itself uphill.

The hanging means the hook engages may be a shackle, a ring, an loop, a bolt or the like. The hanging means is secured in place to be stationary. For preparing a skiing piste, for example, a shackle may be fixed to a post or a tree. etc., at the top of a mountain slope for receiving the movable coupling head with the cable attached thereto and for thus securing the all-terrain vehicle.

In the closed position of the hook, its pivot spindle or axis is disposed on the side of the movable coupling head where the hanging means attacks and opposite the point of attachment of the hauling means on the movable coupling head . Following hook release, this arrangement gives rise to an instable condition in which the hook will pivot to the release position if a pulling force acts on it. To make sure the instable condition exists, i.e. that the hook opens reliably after having been unlatched, the pivot spindle of the hook is made to lie not on the straight line which connects the point of attack of the hanging means with the point of securement of the hauling means but slightly laterally offset from it, preferably by at most 1/10, and more preferably 1/20, of the distance between the point of attack of the hanging means and the securement position of the hauling means, and this on the side opposite the tip of the hook of the aforesaid straight line.

According to an embodiment of the invention, the movable coupling head has pivotally connected thereto a engagement member having therein a recess receiving the tip of the hook, as well as a detent receiving the latching bolt, in the closed position of the hook.

The latching bolt is guided for movement in a direction transverse to the straight line connecting the point of attack (or the point of engagement) of the hanging means with the securement position of the hauling means.

In accordance with another embodiment of the invention, the hook has on the side opposite its tip of its pivoting spindle an extension portion which has at its end facing the movable coupling head a detent for engagement by the latching bolt in the closed position of the hook.

The latching bolt is actuated by an actuator such as an electric motor through a speed-reducing transmission, which actuates the latching bolt via a crank, for example.

The actuator is activated by remote control means. To this end, the device comprises a receiver. The actuator and the receiver are powered by a source of electric current such as a battery. The remote control preferably works by radio. The remote control is activated manually, i.e. in the case of an all-terrain track vehicle used for preparing skiing pistes, by its driver when, following slope preparation, the all-terrain vehicle is standing at the bottom of the slope.

The receiver, the actuator and the power source are mounted preferably on a mounting plate through which the latching bolt extends. The latching bolt is spring-biased to engage the recess provided, in one preferred embodiment of the invention, in the pivotable engagement member and, in the other preferred embodiment, in the extension of the hook. To this end may be provided a compression spring disposed on, and thus guided by, a coupling bar.

The latching bolt preferably has an arm secured thereto which is guided for movement along the coupling bar. To this end the arm preferably has a through-opening in the coupling bar. The arm supports a first compression spring the opposite end of which is secured to the end of the coupling bar which is turned away from the mounting plate.

The actuator preferably engages the coupling bar by a crank the movement of which is transmitted to the latching bolt.

The arm on the latching bolt is supported by an additional compression spring provided on the side of the coupling bar which is turned towards the mounting recess. The additional spring exerts a higher spring force than the spring acting between the arm and the end of the coupling bar which is turned away from the mounting plate.

The detent on the engagement member or on the extension portion, respectively, of the hook is formed by a step in the engagement member or in the end of the hook's extension turned away from the hook's pivot spindle. The step is followed on the engagement member or on the end of the hook extension, respectively, by a curved camming surface. As the engagement member or the hook is urged by hand from the release position to the closed position, the latching bolt engages that camming surface and is shifted against the force exerted by the first spring and between the arm on the latching bolt and the end opposite the mounting plate of the coupling rod towards the mounting plate so as to snap into the stepped detent as the engagement member continues to rotate to its closing position.

The all-terrain vehicle may be a chain-driven or track vehicle. As mentioned above, the invention is intended particularly for the preparation of skiing pistes or the like terrain by using an all-terrain vehicle. It is suited as well for other all-terrain vehicles, however, which are secured by hauling means to a hook on some stationary hang-up means and are supposed to be released under remote control. In particularly, such equipment may be a wood harvester, a skidding hauler, a forwarder or any forestry all-terrain vehicle in general. In these applications, all-terrain vehicles are also employed which on steep terrain are secured by means of a cable, for example.

In the case of an all-terrain vehicle for preparing skiing pistes, the movable coupling head is preferred to have a hook with a pivoting gate member attached thereto by means of which the hook may be closed. This hook is attached to the all-terrain vehicle near its winch after the piste has been prepared, thus keeping the movable coupling head from swinging back and forth uncontrolled at the cable end extending down from the winch, potentially damaging the cab of the piste vehicle.

Further and preferably, the movable coupling head is attached on or at a sled equipped with brake means. After the hook has been released from the hanging means, this sled prevents rapid downhill travel of the cable and the hook to the piste preparation vehicle at the bottom of the slope, which would cause the cable to get entangled with itself or the prepared piste to be damaged, for example.

The brake-equipped sled may be designed in rake form. Attachment of the sled or rake to the movable coupling head may be by a cable one to three metres long, for example, which is held in place in an eye on the movable coupling head , for example. The sled preferably has brake means, or is designed to be in brake form, respectively, on both sides, i.e. on the top and on the bottom thereof. To this end, it may comprise a plate having spines on both sides. Also, the plate may have on both sides longitudinal ribs extending in the direction of travel. Further, the plate may have on both sides edges which cut into the snow surface.

The invention is illustrated below in greater detail under reference to the drawings, which show exemplary embodiments thereof.

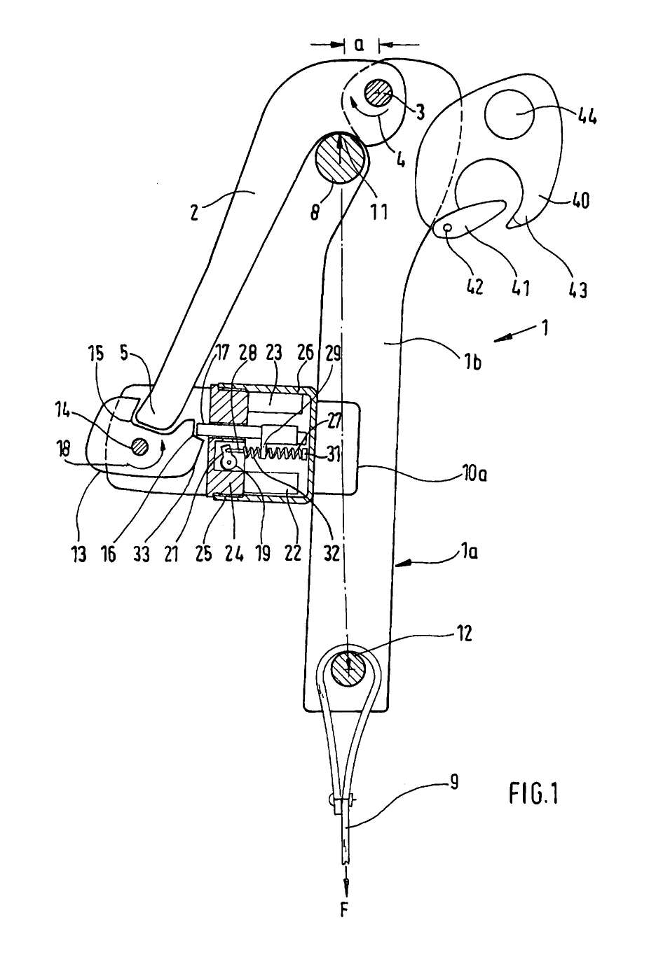

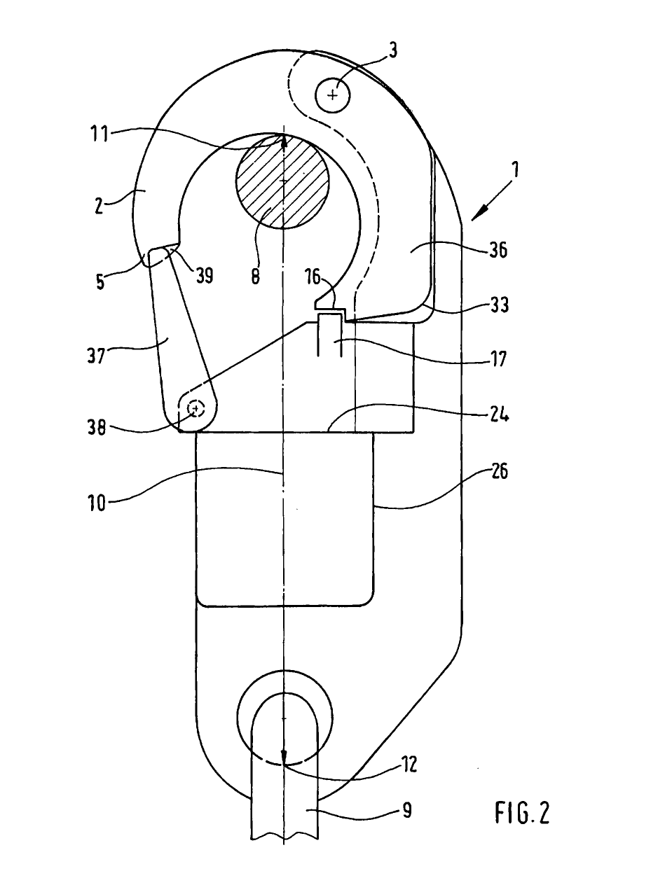

FIG. 1 and FIG. 2 show first and a second embodiment example of the invention in plan in the closed position thereof.

As shown in FIG. 1, the device comprises a movable or pivoting coupling head 1 having a bar-like portion 1 a consisting of an elongated plate portion 1b and an additional plate member coplanar therewith (not shown) so as to form in portion 1a of movable coupling head 1a gap-like interspace between plate portion 1b and said coplanar plate member. At one end of portion 1a of movable coupling head 1, a hook 2 is placed in the space between the two aforesaid plates for pivoting about a pivot spindle 3. To this end, portion 1a of movable coupling head 1 has therethrough a cylindrical bore receiving the bolt forming pivot spindle 3. In the closed position shown in FIG. 1, hook 2 is adapted to be moved, as shown by arrow 4, into a release position (not shown) in which tip 5 of hook 2 is pivoted away from movable coupling head 1 by approximately 180° in the longitudinal direction of bar portion 1a.

In the closed position, the inside of hook 2 reaches around hanging means 8 such as a shackle, a loop or the like which may be fixed in place at some specific terrain position.

Thus hook 2 may be used to hang up to hanging means 8 an all-terrain vehicle connected by hauling means 9 such as a cable with movable coupling head 1 at the end of portion 1a thereof opposite pivot spindle 3.

The two plate members, i.e. plate member 1b and the additional plate member, which make up portion 1a of movable coupling head 1, have therethrough at the end thereof opposite pivot spindle 3 a bolt 7 to which cable 9 or other hauling means is attached by means of a loop.

Hanging means 8 such as a shackle is fastened to a post or pile, for example, at the top of the steep slope.

Pivot spindle 3, the point or place of attack 11 of hanging means 8 and the place or point of securement 12 where hauling means 9 is fastened to movable coupling head 1 are arranged in a relationship such that, in the closed position of hook 2, hanging means 8 engages point of attack 11 between pivoting spindle 3 of hook 2, on the one hand, and securement position 12 where hauling means 9 is attached in place to an object 7, on the other hand. In other words: in the closed position of hook 2, pivot spindle 3 of hook 2 is located on movable coupling head 1 on that side of point of attack 11 of hanging means 8 on hook 2 which is turned away from the place 12 where hauling means 9 is attached by means of object 7.

In the middle thereof, portion 1a has a housing 24, 26 secured thereto (to be discussed in greater detail below) by means of a flange 10a extending into the space between portion 1b and said additional plate member (not shown).

At the end of housing 24, 26 opposite portion 1a, a engagement member 13 is mounted for pivoting movement about a pivot spindle 14 extending in parallel with pivot spindle 3 of hook 2. Receiving member 13 has therein a recess 15 receiving tip 5 of hook 2 in the closed position of hook 2.

In addition, engagement member 13 has thereon a stepped detent 16 to receive a latching bolt 17 in the closed position of hook 2. With latching bolt 17 retracted from detent 2, the pressure hook 2 fastened to hanging means 6 exerts on engagement member 13 causes engagement member 13 to rotate as shown by arrow 18 and thus hook 2 to be pivoted to the release position.

Pivoting spindle 3 of hook 2 is offset laterally from a straight line 10 which connects point of attack 11 of hanging means 6 with securement position 12 of hauling means 9, and this by a small distance (a) equal to at most 1/10 of the distance between point of attack 11 and securement position 12, and offset to the side of straight line 10 opposite tip 5 of hook 2. This offset results in tip 5 of hook 2 exerting a laterally directed force component on engagement member 13. As the weight of object 7 may cause a considerable drag of, say, several tonnes acting on hook 2, this force component may result in considerable clamping forces acting on pivoting spindle 14 of engagement member 13, for example.

Latching bolt 17 is reciprocated by an actuator in a direction transverse to straight line 10 connecting point of attack 11 of hanging means 6 with securement position 12 of hauling means 9, with said actuator comprising an electric motor 19 actuating latching bolt 17 via a crank 21.

Electric motor 19 is activated by remote control. To this end, a receiver 22 is powered by a source of electric current 23 such as a battery, which powers electric motor 19 also. The remote control may be by radio. The remote control transmitter (not shown) is activated by an operator. Electric motor 19, receiver 22, and power source 23 are fastened to a mounting plate 24 through which latching bolt 17 extends.

Mounting plate 24 has around its periphery threads 25 so that a cap 26 may be screwed on threads 25 to form a closed housing.

In the closed position of hook 2, latching bolt 17 is biased to engage detent 16 by a compression spring 27 provided on, and guided by, a coupling rod 28.

Latching bolt 17 has coupled thereto inside housing 24, 26 an arm 29 movably guided relative to coupling rod 28. To this end, arm 29 has therethrough an opening through which coupling rod 28 extends. On the one hand, compression spring 27 acts on arm 29 and on the other hand on a stop 31 at the end of coupling rod 28 opposite mounting plate 24.

Actuated by electric motor 19, crank 21 acts on the other end of coupling rod 28. This way coupling rod 28 acts to transmit the rotation of crank 21 to latching bolt 17.

Arm 29 on latching bolt 17 is supported by a compression spring 32 provided on the side of coupling rod 28 turned towards mounting plate 24. Compression spring 32 exerts a higher force than compression spring 27 between arm 29 and the end of coupling rod 28 opposite mounting plate 24.

In the closed position shown in FIG. 1 of hook 2, the radial edge of stepped detent 16 (radial with respect to pivot spindle 14) on the periphery of engagement member 13 is followed on the side turned away from tip 5 of hook 2 by a curved camming surface 33.

When pivoted to its release position as indicated by arrow 18, engagement member 13 may be returned manually to the closed position shown in FIG. 1. In the process, camming surface 33 engages latching bolt 17, causing it to be shifted against the force of compression spring 27 towards mounting plate 24 until it engages stepped detent 16 upon further rotation.

Slanted edges 34a, 34b on the bottom of transverse beam 1b serve as keep-off rails when the device is dragged across the ground, for example. Further, the device may be mounted on a sled or the like to pull it downhill by means of cable 9 on the ground of a skiing piste, for example. The sled may be equipped additionally with brake means.

In the embodiment shown in FIG. 2, in which the same reference numerals are used as in FIG. 1, hook 2 has on the side opposite tip 5 of pivoting spindle 3 an extension portion 36. Pivoting spindle 3 is mounted in a cylindrical bore of pivoting head 1. Extension 36 has at the end opposite pivoting spindle 3 a stepped detent 16 for engagement by latching bolt 17.

In contrast to that of FIG. 1, the embodiment shown in FIG. 2 has latching bolt 17 mounted for reciprocation in parallel with straight line 10, which connects point of attack 11 for hanging means 8 with securement position 12 for hauling means 9. Further, FIG. 2 shows movable coupling head 1 as mounting a gate member 37 for pivoting movement about pivoting spindle 38 on head 1, said gate member being spring biased and engaging a recess 39 on tip 5 of hook 2 in the closed position shown in FIG. 2.

For the rest, the embodiment of FIG. 2 is similar in configuration to that shown in FIG. 1. This applies in particular to the remotely controlled actuation of latching bolt 17.

As shown in FIG. 1, a hook 40 with a pivoting gate member 41 is mounted on the end of portion 1 a turned towards pivot spindle 3 and between plate 1 b and said additional plate member, said gate member being pivotal about a spindle 42 between an inwardly displaced release position and a closed position aligned with hook end 43 and spring-biased to the latter. This will secure hook 40 in the manner of a karabiner. Hook 40 is intended to hang up movable coupling head 1 near the winch of the all-terrain vehicle when hauling means 9 is wound up on it. Furthermore, plate-shaped hook 40 has an opening 44 therethrough to fasten a sled with braking means—such as a rake—by means of a cable or the like.

1. Apparatus for hanging up an all-terrain vehicle at stationary hang-up means (8) using hauling means (9) and a hook (2) secured thereto, characterized by a movable coupling head (1) to which hauling means (9) is secured and to which hook (2) is attached to pivot between a closed position in which tip (5) of hook (2) is moved towards movable coupling head (1) and a release position in which tip (5) of hook (2) is pivoted away from movable coupling head (1), by a latching bolt (17) guided for sliding movement on movable coupling head (1) for latching hook (2), and by remote control means for activating an actuator to release latching bolt (17).

2. Apparatus as defined in claim 1, characterized in that, in the closed position of hook (2), hanging-up means (8) engages hook (2) at a point (11) thereof between pivoting spindle (3) of hook (2) and a point (12) where hauling means (9) is secured to movable coupling head (1).

3. Apparatus as defined in claim 1 or 2, characterized by pivot spindle (3) of hook (2) being disposed on the side opposite tip (5) of hook (2) of a straight line (10) which connects point of engagement (11) of hanging-up means (8) with securement position (12) of hauling means (9).

4. Apparatus as defined in claim 3, characterized by pivot spindle (3) of hook (2) being offset laterally from straight line (10) by a distance (a) which is not more than 1/10 of the distance between the point of engagement (11) of hang-up means (8) and the securement position (12) of hauling means (9).

5. Apparatus as defined in any one of the preceding claims, characterized by movable coupling head (1) having pivotally mounted thereon a engagement member (13) having therein a recess (15) engaging tip (5) of hook (2) in the closed position thereof, with engagement member (13) having therein a detent (16) engaging latching bolt (17) in the closed position of hook (2).

6. Apparatus as defined in claim 5, characterized by latching bolt (17) being guided for sliding movement in a direction transverse to straight line (10) connecting point of engagement (11) of hang-up means (8) coupling position (12) of hauling means (9).

7. Apparatus as in any one of claims 1 to 4, characterized by hook (2) having on the side opposite tip (5) thereof of its pivoting spindle (3) an extension portion (36) with a detent (16) on the end turned away from pivot spindle (3), said detent receiving latching bolt (17) in the closed position of hook (2).

8. Apparatus as in claim 7, characterized by latching bolt (17) being guided for sliding movement in parallel with straight line (10) which connects point of engagement (11) of hang-up means (8) with the coupling position (12) of hauling means (9).

9. Apparatus as defined in claim 1, characterized by all-terrain vehicle (F) being equipped with a winch for winding hauling means (9) up.

10. Apparatus as defined in claim 9, characterized by all-terrain vehicle (F) comprising an all-terrain vehicle for the preparation of a skiing piste, with hang-up means (8) being fastened in position at the top end of the terrain to be prepared.

11. Apparatus as defined in claim 10, characterized by movable coupling head (1) having attached thereto a sled equipped with brake means.

12. Apparatus as defined in claim 10, characterized by movable coupling head (1) having fastened thereto a hook (40) comprising a pivoting gate member (41).
